(19) United States
(12) Patent Application Publication
(10) Pub. No.: US 2026/0134218 A1
(43) Pub. Date: May 14, 2026

(54) HARDWARE-SECURED SYSTEM FOR EVIDENCE-GOVERNED AI OUTPUT GENERATION WITH TIME-ALIGNED SEMANTIC UNIT VALIDATION

(71) Applicant: Brian Andrew Wilson, Adairsville, GA (US)

(72) Inventor: Brian Andrew Wilson, Adairsville, GA (US)

(73) Assignee: Praegnosis, Inc., Adairsville, GA (US)

(21) Appl. No.: 19/402,663

(22) Filed: Nov. 26, 2025

(51) Int. Cl. G06F 40/30; G06F 21/53; G06F 40/226; G06F 40/253; G06F 40/284; G06F 40/289; G06F 40/40

(52) U.S. Cl. CPC G06F 40/30; G06F 21/53; G06F 40/226; G06F 40/253; G06F 40/284; G06F 40/289; G06F 40/40; G06F 2221/032

(57) ABSTRACT

A computer-implemented method in a hardware-secured mission-critical system governs text outputs produced by a transformer-based language model. A first transformer-based model generates candidate text and machine-identified propositions. A timing subsystem synchronized to PTP, GPS, or IMU clocks timestamps propositions and retrieved reports, logs, and sensor products, and admits only evidence within a configured skew window. Each proposition is segmented into semantic units under a constrained domain grammar that distinguishes subjects, predicates, modifiers, and domain-specific clauses. A second, architecturally isolated transformer-based model receives adversarial prompts built from propositions and summaries of admitted evidence and outputs structured challenge records with challenge types and severities. From evidence associations and challenge records the system constructs a semantic support mask and generates a conservative rewrite that preserves, in order, only tokens mapped to units that satisfy governance thresholds, introduces no new tokens, and passes a grammar-based integrity check before release as governed text output.

### CROSS-REFERENCE TO RELATED APPLICATIONS

This application claims the benefit of a U.S. provisional patent application entitled “Hardware-Secured System for Evidence-Governed AI Output Generation with Time-Aligned Semantic Unit Validation,” filed on Nov. 26, 2025, under 35 U.S.C. 119(e).

This application is related to U.S. patent application Ser. No. 19/373,542, filed Oct. 29, 2025, titled “Guardian Multi-Domain Control Architecture.” The entire disclosure of the prior application is incorporated herein by reference to the extent not inconsistent with the present disclosure.

### STATEMENT REGARDING FEDERALLY SPONSORED RESEARCH OR DEVELOPMENT

This invention was not made with any Government support. The Government has no rights in this invention.

### NAMES OF THE PARTIES TO A JOINT RESEARCH AGREEMENT

None.

### REFERENCE TO SEQUENCE LISTING, A LARGE TABLE, OR A COMPUTER PROGRAM LISTING APPENDIX

Not applicable.

### INCORPORATION BY REFERENCE

The disclosures of the patent applications identified in the CROSS-REFERENCE TO RELATED APPLICATIONS section are incorporated herein by reference in their entireties to the extent necessary to provide background context, terminology, and exemplary implementation details for the systems and methods described herein, and only to the extent not inconsistent with the present disclosure.

### FIELD OF THE INVENTION

This disclosure relates generally to computer implemented systems and methods for governing outputs generated by large language models and other generative artificial intelligence systems. More particularly, the disclosure relates to hardware secured mission critical systems that segment model generated propositions using a constrained semantic grammar, evaluate those propositions against time-aligned evidence and adversarial challenges, and generate conservative rewritten propositions that retain supported content while omitting unsupported inferences.

### BACKGROUND

Large language models (LLMs) and other transformer-based generative models are increasingly used to assist with analytical writing, reporting, and decision support in a wide range of domains. In some consumer applications, occasional factual errors or “hallucinations” can be tolerated or corrected manually. In mission critical environments, however, including intelligence analysis, tactical planning, medical decision support, and safety engineering, unsubstantiated inferences and fabricated facts in model outputs present unacceptable operational and safety risk.

Conventional approaches to governing model outputs typically fall into several categories. Retrieval augmented generation (RAG) systems retrieve documents or passages from a corpus and condition the model on that evidence, but do not provide fine grained guarantees that each individual claim in the output is supported. Post generation critics or detectors may attempt to classify an entire answer as safe or unsafe, often using another model to assign a risk score or label, but generally do not identify which parts of the answer are unsupported or how to repair them. Other systems apply rule based filters or pattern matching to block certain terms or phrases, or to enforce content policies, without reasoning about the evidentiary sufficiency of specific propositions.

In many cases, when a system detects that an answer may be unreliable, the only available responses are to reject the entire answer, to return a generic warning, or to attempt to regenerate a different answer. These behaviors can degrade trust, increase latency, and provide poor operator experience in time sensitive settings. Moreover, they may hide potentially useful fragments of the model's output that are well supported by evidence but are bundled together with unsupported speculation in the same sentence or paragraph.

Existing work on fact checking, claim level analysis, or summarization sometimes decomposes text into sentences or coarse-grained claims and compares them to external sources, but typically does not use a domain specific semantic grammar to segment propositions into subject, predicate, and modifier units for evidentiary analysis. Known adversarial testing tools can generate prompts designed to stress test models, yet those tools are not tightly integrated into a structured governance pipeline that operates at the level of semantic units and produces conservative rewrites rather than merely flags or scores.

In mission critical environments with strict timing and authenticity requirements, there is an additional challenge: evidence and sensor data must be time-aligned within a bounded skew. Generic software clocks and asynchronous data flows can undermine trust in any evidentiary reasoning if the system cannot reliably determine which information was valid at the time a proposition was generated. Likewise, sharing parameters or internal state between a generating model and a criticizing model can lead to correlated blind spots and reduce the effectiveness of adversarial challenges.

Accordingly, there is a need for systems and methods that (1) operate within a hardware secured mission critical environment, (2) segment model generated propositions into semantic units using a constrained grammar tailored to evidentiary support analysis, (3) evaluate those units against time-aligned evidence and structured adversarial challenges produced by an architecturally isolated model, and (4) generate conservative rewritten propositions that preserve only supported units while omitting unsupported inferences, rather than simply rejecting entire answers. There is a further need for such systems to provide machine readable governance signals and logs that can be integrated into downstream automated systems and audit workflows.

The presently disclosed system and methods provide a technical solution to these technical problems by integrating a specific, unconventional hardware and software architecture. This architecture imposes tangible constraints on the AI governance process through a hardware timing subsystem enforcing strict evidence admissibility, architectural isolation of neural network models to prevent correlated failures, and a semantic grammar-driven rewriting process. This solution moves beyond the abstract idea of “fact-checking” by reciting a particular, non-conventional technical arrangement that is necessarily rooted in computer technology to overcome problems arising in the realm of mission-critical computer systems.

### BRIEF SUMMARY OF THE INVENTION

In one aspect, a computer implemented method is provided for governing outputs generated by a transformer-based language model in a hardware secured mission critical environment. The method is executed by at least one hardware processor coupled to a non-transitory memory and to a hardware timing subsystem that provides trusted timestamps, such as precision time protocol (PTP), global positioning system (GPS), and inertial measurement unit (IMU) signals.

The method includes receiving an input prompt and causing a first transformer-based language model to generate a candidate text output. The first model is the only model permitted to generate candidate text outputs that can become governed text outputs. The method further includes identifying one or more machine identified propositions within the candidate text output using token span extraction driven by dependency parsing.

For each machine identified proposition, the method performs a semantic segmentation into a sequence of semantic units, such as a subject phrase, predicate phrase, modifier phrase, or subordinate clause, according to a constrained semantic grammar configured for evidentiary support analysis. The method retrieves evidence items from internal and external corpora, associates hardware derived timestamps with evidence items and propositions, and discards evidence items that violate a configured skew bound relative to the proposition timestamp. The remaining skew compliant evidence items are used to construct an evidence representation that associates evidence items with semantic units.

In some embodiments, evidence items whose timestamps violate the configured skew bound are omitted from the context passed to the second transformer-based language model instance and from the evidence representation used for support scoring, such that the adversarial prompt, challenge generation, and support score computation all operate exclusively over skew-compliant evidence items. The adversarial prompt is provided to a second transformer-based language model instance that executes as an architecturally isolated, logically independent process without parameter sharing with the first model. The second model is configured exclusively to generate adversarial challenge outputs critiquing evidentiary sufficiency and is not permitted to generate candidate or governed text outputs.

The method parses the adversarial challenge output into structured challenge records that include challenge type labels, semantic unit references, and numerical severity values on a predefined scale. Using the evidence representation and structured challenge records, the method computes a support score for each semantic unit as a function of evidence weights and a penalty term that increases with missing evidence indications. The method then assigns each semantic unit to a first state or a second state based on support scores, a support threshold specified by a governance profile, and the presence of “unsupported_inference” challenge records above a configured severity threshold, thereby forming a semantic support mask.

Using the semantic support mask, the method constructs a conservative rewritten proposition by preserving, in order, tokens mapped to semantic units in the first state and omitting tokens mapped exclusively to semantic units in the second state, without introducing any new tokens. A syntactic and semantic integrity check is performed on the conservative rewritten proposition using the constrained semantic grammar, and when the check passes, the conservative rewritten proposition replaces the original proposition within a governed text output.

In this manner, the governed text output is configured to be logically weaker than the original candidate text output and free of unsubstantiated inferences according to the support threshold and severity threshold criteria of the governance profile, while preserving grammar and domain specific semantics. This logical-weakening and unsubstantiated-inference-free property is achieved deterministically through the semantic support mask and token-subsequence construction process described above, without requiring any separate logical inference engine. Unlike systems that simply redact or remove entire propositions when reliability is questioned, the described method produces maximally evidence supported conservative rewrites that retain the informational core of the proposition while excising only unsupported elements. In some embodiments, the governance pipeline is implemented to satisfy a bounded end-to-end latency budget appropriate to the mission critical environment, so that governed text outputs and governance signals are generated within decision cycles of associated mission systems.

In another aspect, a system is provided comprising at least one hardware processor, a non-transitory computer readable memory storing instructions to implement any of the methods described herein, one or more hardware time sources configured to provide trusted timestamps for propositions and evidence items, a first transformer-based language model, and an architecturally isolated second transformer-based language model instance. In yet another aspect, a non-transitory computer readable medium stores instructions that, when executed by one or more processors, cause performance of any of the methods described herein.

The described methods and systems are applicable in multiple domains, including intelligence analysis and tactical planning, medical decision support, financial forecasting, and safety or certification engineering, with constrained semantic grammars and governance profiles adapted to each domain. In some embodiments, governed text outputs, proposition level support metrics, and governance state codes are presented to human analysts; in other embodiments, the same outputs are consumed directly by downstream automated systems in a headless configuration for gating actions, routing alerts, or enforcing policy.

### BRIEF DESCRIPTION OF THE DRAWINGS

FIG. 1 is a block diagram illustrating an example system architecture for governed large language model outputs in a hardware secured mission critical environment, including a secure computing node, a hardware timing subsystem, hardware security components, a first transformer-based language model, an architecturally isolated second transformer-based language model instance, and governance pipeline modules.

FIG. 2 is a flow diagram illustrating an example governance pipeline for a machine identified proposition, including proposition identification, semantic segmentation, evidence retrieval and time alignment, adversarial prompting and challenge parsing, support scoring, semantic support mask formation, conservative rewriting, and integrity checking.

FIG. 3 is a diagram illustrating an example constrained semantic grammar and semantic unit segmentation for an intelligence analysis domain, including production rules mapping a proposition into semantic units such as Tactical_Entity, Activity, Location, Timeframe, and Capability_Modifier, and an example proposition segmented into corresponding semantic units.

FIG. 4 is a diagram illustrating an example evidence representation for a segmented proposition, including nodes representing semantic units and evidence items, edges indicating supporting or contradicting relationships, associated evidence weights, and structured challenge records that reference specific semantic units and augment the evidence representation with challenge type and severity information.

FIG. 5 is a diagram illustrating formation of a semantic support mask and construction of a conservative rewritten proposition, including assignment of first and second states to semantic units, creation of a token-level inclusion mask, and emission of a conservative rewritten proposition that preserves tokens mapped to first-state units and omits tokens mapped exclusively to second-state units.

FIG. 6 is a diagram illustrating governance profiles, threshold parameters, and proposition-level support metrics, including a table of governance profiles specifying support thresholds, severity thresholds, penalty factors, and severity scales, and a visualization of proposition-level support metrics derived from support scores, missing-evidence penalties, and semantic support masks.

FIG. 7 is a schematic view of an example user interface presenting governed text outputs and governance metadata, including governed propositions with inline annotations, a detail panel showing original and conservative propositions, semantic units and their states, associated evidence items, structured challenge records, and proposition-level support metrics.

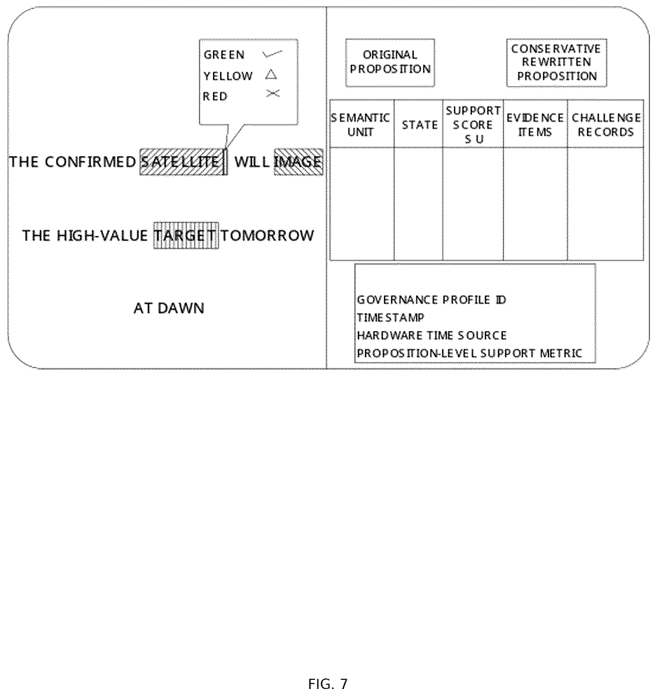

FIG. 8 is a block diagram illustrating deployment of the governed-output system in a mission critical environment with hardware time sources and downstream integration, including a secure computing node connected to PTP, GPS, and IMU hardware time sources, mission data sources, and downstream mission systems that consume governed text outputs, proposition-level support metrics, and governance state codes.

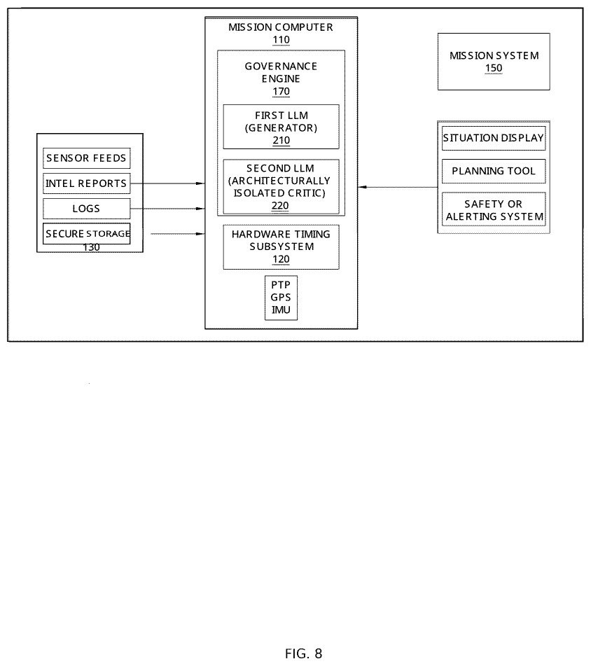

### DETAILED DESCRIPTION OF THE INVENTION

The following detailed description is provided to enable any person skilled in the art to make and use the disclosed systems and methods and is not intended to limit the scope of the claims. Where appropriate, like reference numerals refer to like elements across figures. Unless explicitly stated otherwise, examples and embodiments are illustrative and not limiting.

The various functional modules, components, and systems described herein, including but not limited to the governance engine 170, evidence retrieval and representation module 230, semantic segmentation module 240, and others, are implemented as dedicated hardware circuits, configured programmable hardware processors executing software instructions, or a combination thereof. The limitations of the claims are intended to cover such implementations, and no claim term is intended to be interpreted under 35 U.S.C. § 112(f) unless the exact phrase “means for” is explicitly used in the claim limitation.

At a high level, the disclosed technology provides a governance layer for large language model (LLM) outputs in hardware secured mission critical systems. A first model instance generates candidate text that may include one or more machine identified propositions. A second, architecturally isolated model instance generates adversarial challenge outputs directed at those propositions. A constrained semantic grammar is used to segment each proposition into semantic units. Evidence items are retrieved and associated with the semantic units, and adversarial challenge outputs are parsed into structured challenge records that reference specific semantic units. A semantic support mask is computed based on evidence associations, support scores, and challenge severities. A conservative rewrite is produced by preserving, in order, tokens mapped to units that satisfy criteria defined by a governance profile and omitting tokens mapped exclusively to units that do not satisfy those criteria. A grammar based integrity check is then applied before governed text is released to downstream mission systems.

### GLOSSARY

### Hardware Secured Mission Critical System

The term “hardware secured mission critical system” refers to a computing system, platform, or networked environment in which one or more mission critical applications execute on hardware that is configured to resist tampering and to maintain reliable operation under adverse conditions. Such a system may include, for example, trusted platform modules, secure boot, hardware based attestation, physically protected enclosures, or real time operating systems deployed on hardened processors. In some embodiments, the system is deployed in safety or mission critical domains such as defense, aviation, transportation, industrial control, emergency response, or critical infrastructure. In a hardware secured mission critical system, hardware level protections are used to support one or more of integrity, timing, and isolation properties relevant to the mission workload.

### Hardware Timing Subsystem

The term “hardware timing subsystem” refers to one or more components that provide time references derived from physical hardware sources. Examples include, without limitation, precision time protocol (PTP) clocks, global positioning system (GPS) receivers, inertial measurement units (IMUs) with disciplined oscillators, and other hardware assisted time references. A hardware timing subsystem may generate timestamps for evidence items and model operations, may enforce configured skew bounds between time sources, and may provide timing metadata that is used by the governance system to admit or discard evidence and to constrain the context available to one or more language models.

### Machine Identified Proposition

The term “machine identified proposition” refers to a span of text that is identified by a model or parsing component as expressing a discrete factual, inferential, or prescriptive statement. In various embodiments, a machine identified proposition may be obtained by applying token span extraction using dependency parsing, sequence tagging, or similar natural language processing techniques to model generated text. A machine identified proposition may be associated with one or more semantic units as defined below.

### Semantic Unit

The term “semantic unit” refers to a sub span of a machine identified proposition that is treated as an atomic unit for evidence evaluation, challenge analysis, and conservative rewriting. In some embodiments, a semantic unit corresponds to at least one of: a subject phrase, a predicate phrase, a modifier phrase, or a subordinate clause, as determined according to a constrained semantic grammar. Multiple semantic units may together represent the full content of a machine identified proposition.

### Constrained Semantic Grammar

The term “constrained semantic grammar” refers to a set of grammar rules and associated parsing logic that define how machine identified propositions are decomposed into semantic units for purposes of evidence evaluation and conservative rewriting. In one embodiment, the constrained semantic grammar includes production rules such as:
S->Subject Predicate [modifier]*

where S denotes a sentence level structure, “Subject” denotes a subject phrase, “Predicate” denotes a predicate phrase, and “Modifier” denotes an optional modifier phrase. Other embodiments may define grammars for particular domains, such as medical diagnosis, financial risk assessment, or tactical intelligence, with domain specific rules that identify which parts of a proposition can be independently validated or challenged against evidence items. The constrained semantic grammar may be implemented using context free grammars, dependency templates, slot and filler patterns, learned grammars, or combinations thereof.

### Evidence Item

The term “evidence item” refers to a unit of information used to support or refute one or more semantic units. Evidence items may include, for example, sentences or paragraphs from source documents, database records, telemetry records, sensor readings, satellite imagery derived annotations, or other structured or unstructured data. Evidence items may be retrieved from one or more internal or external corpora, may be associated with timestamps from the hardware timing subsystem, and may be given weights that reflect relevance, trust level, or source quality.

### Evidence Representation

The term “evidence representation” refers to a structured data representation that encodes evidence items and their relationships to semantic units of one or more machine identified propositions. In various embodiments, an evidence representation may include nodes representing evidence items, nodes representing semantic units, and edges or associations that indicate which evidence items support which semantic units. Associations may be generated, for example, using cross attention mechanisms, similarity scoring, or other alignment techniques.

### Architecturally Isolated Model Instance

The term “architecturally isolated model instance” refers to a deployed machine learning model that is executed in a runtime environment that is logically or physically separated from another model instance. Architectural isolation may be achieved, for example, by executing the models in separate processes, containers, virtual machines, physical hosts, hardware partitions, or combinations thereof, such that the models do not share parameters or internal state and interact only through structured inputs and outputs. In various embodiments, an architecturally isolated model instance used for adversarial analysis is configured exclusively to generate challenge outputs and is not permitted to generate candidate or governed text outputs.

### Adversarial Challenge Output

The term “adversarial challenge output” refers to the output generated by an architecturally isolated model instance in response to an adversarial prompt that requests critique, challenge, or stress testing of a machine identified proposition. An adversarial challenge output may identify potential unsupported inferences, missing evidence, contradictions, or other issues in the proposition. In various embodiments, the adversarial challenge output is further parsed into one or more structured challenge records.

### Structured Challenge Record

The term “structured challenge record” refers to a data structure derived from an adversarial challenge output that encodes a challenge in a machine interpretable form. In some embodiments, a structured challenge record includes: (a) a challenge type label drawn from a predefined set (for example, “unsupported_inference”, “missing_evidence”, “contradiction”, or other domain specific labels); (b) a reference that identifies, by index, position, or identifier, a specific semantic unit to which the challenge applies; and (c) a numeric severity value selected from a predefined severity scale. Additional fields, such as rationales or references to evidence items, may be included in some embodiments.

### Support Score

The term “support score” refers to a quantitative value computed for a semantic unit that reflects the degree to which the unit is supported by evidence and not undermined by challenges. In one embodiment, for a given semantic unit, the support score S_u is computed as:

$$S\_u = ( sum of evidence weights for evidence items associated with the unit ) \text{} / ( N + beta * M )$$

where N is the number of associated evidence items, M is a count or aggregate of missing evidence indications or similar penalties for the unit, and beta is a penalty factor greater than zero. This formulation differs from simple weighted averaging by incorporating the beta*M term in the denominator, which ensures that missing or expected but absent evidence actively reduces the support score rather than being ignored. Other monotonic or bounded functions may be used to compute a support score, provided that the resulting value can be compared to a support threshold specified by a governance profile.

### Support Threshold

The term “support threshold” refers to a configured numeric threshold specified by a governance profile that is used to evaluate support scores for semantic units. In various embodiments, a semantic unit whose support score is greater than or equal to the support threshold is treated as sufficiently supported for the purposes of conservative rewriting, while a semantic unit whose support score is below the support threshold is treated as insufficiently supported. Support thresholds may be domain specific and may be calibrated using historical data, simulations, or human in the loop evaluations.

### Severity Threshold

The term “severity threshold” refers to a configured numeric threshold specified by a governance profile that is applied to severity values in structured challenge records. For example, in some embodiments, only structured challenge records of type “unsupported_inference” whose severity value meets or exceeds the severity threshold may be permitted to change the state of a semantic unit to a disallowed or second state. Severity thresholds may be defined on a predefined scale, such as a 1 to 10 scale, and may vary by domain, mission context, or semantic unit type.

### Semantic Support Mask

The term “semantic support mask” refers to a data structure that, for a given machine identified proposition, assigns a state to each semantic unit according to the unit's support score, associated challenge records, and the applicable governance profile. In some embodiments, the semantic support mask assigns, to each semantic unit, a first state when the unit is mapped to at least one admissible evidence item and is not the subject of an “unsupported_inference” challenge with severity above the severity threshold, and assigns a second state when the unit lacks admissible evidence or is the subject of an “unsupported_inference” challenge with severity above the severity threshold. The semantic support mask may be represented, for example, as a list of binary values, a token level mask, or other equivalent representation.

### Conservative Rewrite

The term “conservative rewrite” refers to a rewritten version of a machine identified proposition that is produced by applying a semantic support mask and constrained semantic grammar to the original proposition. In some embodiments, a conservative rewrite is generated by preserving, in their original order, only those tokens that are mapped to semantic units having the first state, and by omitting tokens mapped exclusively to semantic units having the second state. In other embodiments, placeholder tokens may be inserted where all units of a proposition have the second state. A conservative rewrite is grammatically validated using the constrained semantic grammar and is logically weaker according to the support threshold and severity threshold criteria of the applicable governance profile, in that it removes or neutralizes units that fail those criteria while retaining units that satisfy them. The conservative rewrite is configured, by the foregoing token preserving and token omitting steps and grammar based checks, not to introduce new inferences beyond those attributable to semantic units that satisfy the governance profile criteria.

### Governed Text Output

The term “governed text output” refers to model generated text that has been processed by the governance system and has passed the applicable support and challenge criteria defined by a governance profile. In various embodiments, governed text output is formed by replacing one or more machine identified propositions in an original model output with conservative rewrites that have passed a syntactic and semantic integrity check, by masking or annotating unsupported propositions, or by omitting propositions that cannot be brought into compliance. A governed text output is constrained such that, after evaluation and any conservative rewriting, no semantic unit that remains in the governed text output fails the support and challenge criteria defined by the applicable governance profile.

### Governance Profile

The term “governance profile” refers to a configuration object or set of configuration parameters that specifies how the governance system evaluates propositions for a particular domain, mission, or deployment. A governance profile may specify, for example, one or more constrained semantic grammars, support thresholds, severity thresholds, evidence source policies, unit type taxonomies, domain specific mappings between semantic unit types and evidence or penalty weights, and logging or disclosure requirements. Different governance profiles may be defined for different domains such as intelligence analysis, safety assessments, legal drafting, financial analysis, or other applications.

### Unsupported Inference

The term “unsupported inference” refers to a class of model behavior in which a semantic unit asserts a conclusion, causal relationship, probability, or other claim that is not adequately supported by available evidence items. In some embodiments, “unsupported_inference” is used as a challenge type label in structured challenge records generated by an architecturally isolated model instance, and indicates that the challenged semantic unit should be subject to stricter gating based on severity, independent of evidence coverage for other units.

### Mission System

The term “mission system” refers to a system, application, or platform that performs mission relevant functions in a mission critical environment. Examples include, without limitation, command and control systems, decision support systems, safety monitoring systems, and operational planning systems. A mission system may use governed text outputs generated by the governance system as inputs to its workflows, displays, or automated decision making logic.

### Downstream Mission System

The term “downstream mission system” refers to a mission system, data store, or external component that receives governed text outputs, associated metrics, or proof bundles from a governance system, and can use them to trigger, for example, workflows, alerts, recommendations, reports, or automated actions. In some embodiments, a downstream mission system may be an external platform integrated via an application programming interface, a human operator workstation, or a logging and audit subsystem.

### Proof Bundle

The term “proof bundle” refers to a collection of artifacts associated with one or more governed text outputs that is suitable for audit, traceability, or forensic analysis. A proof bundle may include, for example, identifiers of source documents, hashes or digests of input artifacts, records of evidence items and their timestamps, semantic support masks, support scores, challenge records, governance profile identifiers, and decision logs. In some embodiments, a proof bundle may be stored or transmitted in a format that may be tamper evident or cryptographically protected.

### Guardian Researchai (GRAI) System

The term “Guardian ResearchAI (GRAI) system” refers to an example implementation of a governance system that embodies the methods and systems described herein in the context of intelligence asset and tactical plan engineering. In some embodiments, a Guardian ResearchAI system may integrate one or more language models, governance engines, evidence stores, hardware timing subsystems, and user interfaces. Unless explicitly recited in the claims, references to Guardian ResearchAI or GRAI are provided as illustrative examples and do not limit the scope of the claimed invention.

### RedCell View

The term “RedCell view” refers to an example user interface or reporting view that presents adversarial challenge results, semantic support masks, and related governance information for a governed text output. A RedCell view may, for example, highlight challenged units, display support scores and severity values, and show conservative rewrites alongside original propositions. Unless explicitly recited in the claims, any particular presentation, layout, or naming of such a view is optional and does not limit the claimed methods and systems.

### Humanly Impossible Transformation

The term “humanly impossible transformation” refers to a data processing operation that cannot be performed by a human being within any practical or relevant timeframe due to the volume, velocity, or complexity of the data involved, and which is only made possible by the specific technical architecture of the disclosed system. The governance pipeline described herein performs a humanly impossible transformation by ingesting a candidate text output, segmenting it into semantic units, retrieving and time-aligning millions of potential evidence items from disparate corpora using hardware-derived timestamps, generating and parsing adversarial challenges from an architecturally isolated multi-billion parameter neural network, and constructing a conservative rewrite—all within a bounded latency budget (e.g., sub-second) required by mission-critical decision cycles. This end-to-end process is not merely automated but is fundamentally incapable of being performed by human mental steps alone.

### Logically Weaker and Free of Unsubstantiated Inferences

A governed text output is “logically weaker” than the candidate text output, and is “free of unsubstantiated inferences” according to a governance profile, when the governed text output consists solely of tokens mapped to semantic units that have been assigned the first state pursuant to steps (n)-(p) of claim 1—that is, every remaining semantic unit satisfies both (i) the support score threshold for its unit type and (ii) the absence of any unsupported_inference challenge record with severity greater than or equal to the severity threshold specified by the governance profile. This property is a mechanical consequence of the semantic support mask and conservative rewrite process and requires no external logical entailment analysis.

### System Overview

In one group of embodiments, the disclosed systems and methods are implemented in a hardware secured mission critical system that includes one or more mission computers, one or more hardware timing subsystems, persistent storage, secured network interfaces, and one or more accelerator devices such as graphics processing units (GPUs) or tensor processing units (TPUs). The mission critical system may be deployed in an operations center, command post, vehicle, aircraft, ship, industrial facility, or other environment where AI generated outputs may affect safety, security, or critical decision making.

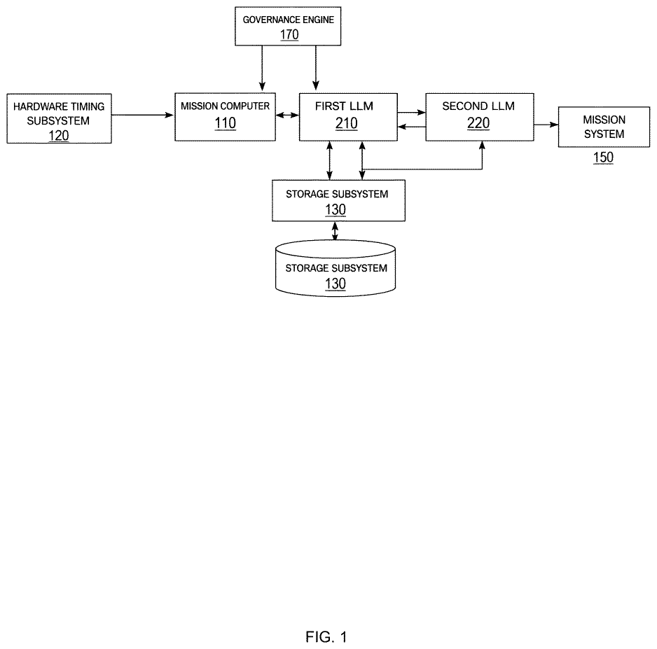

FIG. 1 illustrates, in one embodiment, a hardware secured mission critical system 100. System 100 includes at least one mission computer 110, a hardware timing subsystem 120, a storage subsystem 130, an accelerator subsystem 140, and one or more mission systems 150, all coupled through one or more secure interconnects 160. In some embodiments, the mission computer 110 executes a governance engine 170 that implements the methods described herein. The governance engine 170 may be deployed as a hardened service in a secure enclave, on a standalone appliance, or in a distributed fashion across multiple nodes, provided that architectural isolation between model instances and hardware timing constraints are preserved. The governance engine 170 is not merely a software implementation of an abstract idea but is a specific technical tool designed to interface with and be constrained by the hardware timing subsystem 120. The operation of the governance pipeline is a humanly impossible transformation (as defined herein), as it requires the processing speed, precision timestamping, and computational capacity of the described hardware to function within the operational latency bounds of the mission systems 150.

The hardware timing subsystem 120 may include one or more of: a Precision Time Protocol (PTP) clock, a Global Positioning System (GPS) receiver, an inertial measurement unit (IMU), a disciplined oscillator, or other hardware time sources. The hardware timing subsystem 120 provides time synchronization signals and timestamp metadata used to enforce maximum timing skew between the mission computer 110 and external data sources. Timing metadata may also be provided to mission systems 150 and to secure logging components.

The storage subsystem 130 may include non-transitory memory and storage devices, such as solid state drives, persistent memory modules, and secure key storage. The storage subsystem 130 may persist governance profiles, constrained semantic grammars, model parameters, evidence indexes, support score calibration data, and governance logs. The accelerator subsystem 140 provides hardware acceleration for executing the first and second model instances. Accelerators may be directly attached to the mission computer 110 or accessed over a secure fabric.

Mission systems 150 represent downstream systems that consume governed text outputs produced by the governance engine 170. Mission systems may include situational awareness displays, planning tools, safety systems, communication systems, or other applications that may rely on AI generated text. In some embodiments, mission systems 150 may be configured to consume governed outputs preferentially or exclusively.

### Governance Engine Architecture

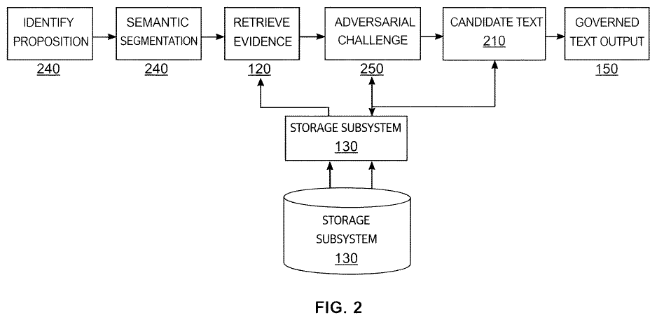

FIG. 2 illustrates, in one embodiment, a functional architecture 200 of the governance engine 170. Architecture 200 includes a first model instance 210, a second model instance 220, an evidence retrieval and representation module 230, a semantic segmentation module 240, an adversarial challenge parsing module 250, a support scoring module 260, a semantic support mask module 270, a conservative rewrite module 280, an integrity check module 290, and a governance logging module 295.

In some embodiments, the first model instance 210 is a transformer-based large language model configured to generate candidate text responses 212 based on prompts, context, or conversation history. The first model instance 210 may be fine-tuned for particular mission critical domains. The first model instance 210 produces the candidate content that may undergo governance.

The second model instance 220 is an architecturally isolated model instance configured exclusively to generate adversarial challenge outputs 222. The second model instance 220 may be a separate instance of the same base model, a different model, or a composition of models. Architectural isolation may be achieved through separate processes, containers, virtual machines, physical hosts, hardware partitions, or combinations thereof, such that the model instances do not share parameters or internal state and interact only through structured prompts and outputs.

The architectural isolation of the second transformer-based language model instance 220 is a critical, non-conventional technical feature that prevents the propagation of correlated errors or “hallucinations” between the generating and critiquing models. This isolation, enforced through separate processes, containers, or hardware partitions, is a technical solution to a technical problem inherent in using large language models for self-correction and is not simply the computerization of a human review process.

The evidence retrieval and representation module 230 accesses one or more internal or external corpora 232, such as document stores, knowledge bases, logs, or databases. For a given machine identified proposition, the module 230 retrieves evidence items subject to timing and source constraints specified by a governance profile. The module 230 constructs an evidence representation that may include nodes representing evidence items, attributes such as source, classification, and timestamp, and semantic associations between evidence items and semantic units.

The semantic segmentation module 240 identifies machine identified propositions within candidate text 212 and segments each one into semantic units. In some embodiments, the module 240 applies a dependency parser, such as one implemented using a library like spaCy, to identify clause boundaries, heads, and dependents, and then applies a constrained semantic grammar.

The adversarial challenge parsing module 250 receives adversarial challenge outputs 222 generated by the second model instance 220 in response to adversarial prompts constructed from semantic units and evidence summaries. The module 250 parses the adversarial challenge outputs into structured challenge records that identify challenge types, semantic unit references, and severity values.

The support scoring module 260 computes support scores for semantic units based on their associated evidence and challenge records. In some embodiments, a function such as:

$$S\_u = ( sum of w\_i ) / ( N + beta * M )$$

may be used, where S_u is the support score for unit u, w_i are evidence weights, N is the number of evidence items, M is a count of missing-evidence indications, and beta is a penalty factor. Other monotonic or bounded functions may be used.

The semantic support mask module 270 assigns a first state or second state to each semantic unit based on support scores, challenge types, and severity values according to a governance profile. The resulting mask may be represented as a sequence of labels, a binary array, or other equivalent representation.

The conservative rewrite module 280 applies the semantic support mask to the candidate text 212. The module preserves, in order, tokens mapped to semantic units in the first state and omits tokens mapped exclusively to semantic units in the second state. No new tokens are introduced.

The integrity check module 290 validates the conservative rewrite using the constrained semantic grammar and one or more parsing or validation algorithms. If the integrity check passes, the conservative rewrite is accepted as the governed version of the proposition. If the integrity check fails, fallback behaviors may be applied according to the governance profile.

The governance logging module 295 records governance events, including candidate text, evidence items considered, structured challenge records, semantic support masks, conservative rewrites, and governance decisions, along with timing and provenance metadata. In some embodiments, the logging module 295 may generate proof bundles containing relevant artifacts.

### Hardware Timing and Evidence Admissibility

In some embodiments, evidence items retrieved from corpora 232 include timestamps. The governance engine 170 may compute timing skew between hardware timing subsystem 120 time signals and evidence timestamps, and may discard or mark as inadmissible evidence items whose skew exceeds a maximum value specified by a governance profile.

Adversarial prompts may be constructed only from evidence items that satisfy timing skew and source reliability thresholds. Timing metadata may also be combined with other attributes such as source classification or reliability, and may influence admissibility scoring or evidence weights.

The integration of the hardware timing subsystem 120 to enforce skew bounds is not a generic “do it on a computer” step. It is a specific technical mechanism that ensures the temporal validity of evidence used for validation, a requirement that is important in dynamic, mission-critical environments where data freshness is paramount. This hardware-imposed constraint directly contributes to the humanly impossible transformation by requiring millisecond or microsecond-level synchronization that cannot be mentally tracked or applied by a human analyst.

### Semantic Segmentation and Constrained Grammar

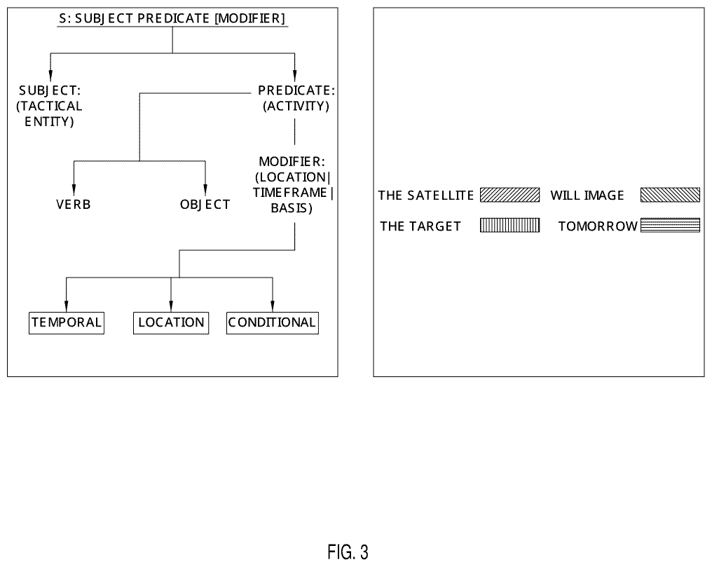

FIG. 3 illustrates, in one embodiment, a constrained semantic grammar and segmentation process 300. A simplified example grammar for an intelligence domain may include:
S->Subject Predicate [modifier]*
Subject->NounPhrase
Predicate->VerbPhrase [ObjectPhrase]
Modifier->Temporalphrase|Conditionalphrase|Qualifierphrase

The constrained grammar supports both segmentation and integrity checking. By restricting the structure of propositions, the grammar enables identification of subject, predicate, and modifier units and defines how a proposition may be rewritten while retaining grammatical validity.

### Evidence Representation and Associations

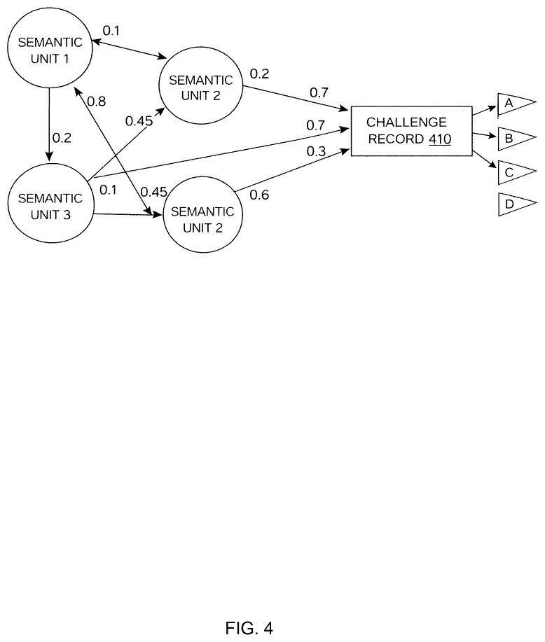

FIG. 4 illustrates, in one embodiment, an evidence representation 400. Evidence items 402 may include text documents, reports, sensor logs, database entries, or other artifacts. Semantic associations 404 between semantic units 406 and evidence items 402 may be computed using a cross-attention mechanism, embedding similarity scoring, or other alignment functions.

### Adversarial Challenge Generation and Parsing

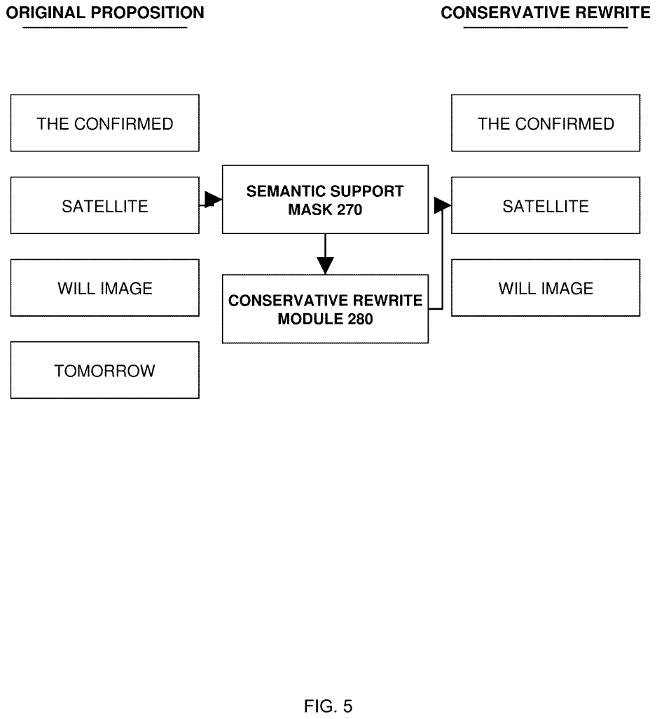

FIG. 5 illustrates, in one embodiment, an adversarial challenge generation and parsing process 500. The governance engine 170 constructs adversarial prompts 502 that present the proposition, its semantic unit segmentation, and summaries of associated evidence items to the second model instance 220. The second model instance 220 generates adversarial challenge outputs 222, which are parsed into structured challenge records 504 according to a predefined schema.

### Support Scoring and Semantic Support Mask

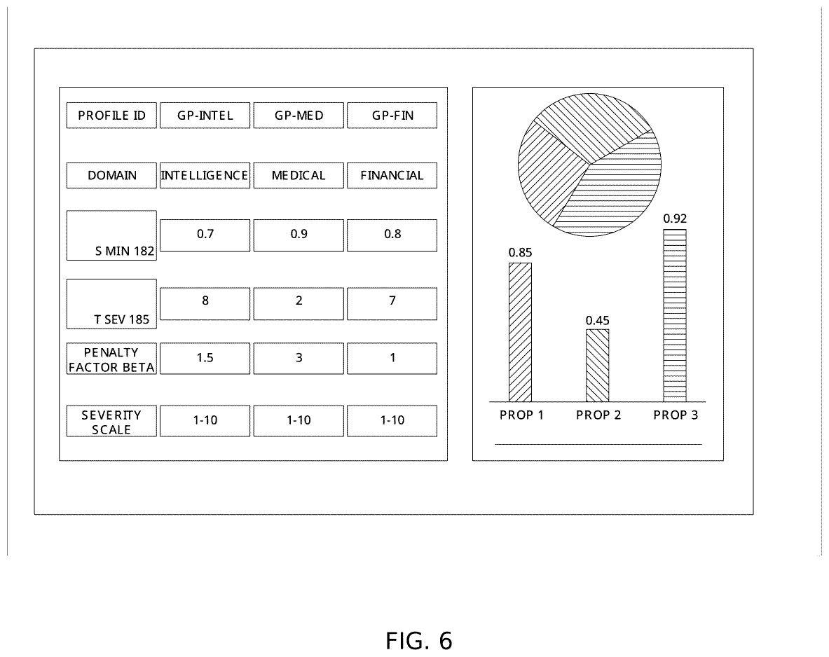

FIG. 6 illustrates, in one embodiment, a support scoring and semantic support mask process 600. The support scoring module 260 computes support scores for each semantic unit using evidence weights and penalties. The semantic support mask module 270 assigns states to semantic units based on support scores and challenge severity values defined in the governance profile.

### Conservative Rewrite and Integrity Checking

The conservative rewrite module 280 applies the semantic support mask to generate a rewritten proposition. Tokens mapped to first-state units are preserved; tokens mapped exclusively to second-state units are omitted. Placeholder text may be inserted when all units of a proposition are in the second state.

The integrity check module 290 validates the rewrite using the constrained semantic grammar. If validation fails, fallback behaviors such as redaction or quarantine may be invoked according to the governance profile.

### Governance Profiles and Policies

Governance profiles configure the behavior of the governance engine 170 for different domains or roles. A governance profile may specify constrained grammars, timing skew limits, evidence source policies, support thresholds, severity thresholds, penalty factors, fallback behaviors, and logging policies. Governance profiles may be versioned and stored so that any governed output can be reconstructed under the exact configuration in effect at the time of generation.

### Operational Embodiments of the GRAI Architecture

The following operational embodiments illustrate example deployments in different mission critical environments and domains. These embodiments are consistent with the claims and the detailed description and are intended to provide concrete examples only.

### Additional Embodiments and Variations

The systems and methods described herein are not limited to the specific embodiments, architectures, or parameter values described. Other variations, modifications, and alternatives will be apparent to persons skilled in the art.

For example, either or both model instances may be implemented using architectures other than transformer-based models. The constrained semantic grammar may include additional production rules or domain-specific structures. Support scoring may use alternative monotonic or bounded functions. Timing metadata may be combined with reliability metadata for admissibility scoring. Deployment architectures may vary, including standalone appliances or distributed services.

It is intended that the appended claims be interpreted to cover all such modifications, equivalents, and alternatives that fall within their scope, and that no limitation in the examples above be read into the claims unless explicitly recited.

### APPENDIX A—IMPLEMENTATION NOTES (NON-CLAIMING)

This Appendix provides non-limiting implementation notes for engineers and architects who may wish to implement the disclosed governance pipeline. The contents of this Appendix are illustrative only and are not intended to define or limit the scope of the claimed invention. In case of any inconsistency between this Appendix and the claims, the claims shall control.

In some embodiments, the governance engine is implemented as a set of software services or modules deployed on a mission computer that includes general purpose processors and accelerator devices such as graphics processing units. The services may be implemented in one or more programming languages, for example C++, Rust, Go, or Python, and may make use of existing libraries for natural language processing, transformer-based language models, dependency parsing, and graph processing. Off the shelf libraries for tokenization, dependency parsing, and semantic role labeling may be adapted to implement constrained semantic grammars and semantic unit identification logic.

In one group of embodiments, the first and second transformer-based language model instances are served using an inference framework that supports model quantization, tensor parallelism, and batching. The first model instance may be configured as a general purpose text generator with access to mission prompts and context, while the second model instance is configured as a critic that receives adversarial prompts constructed from machine identified propositions and associated evidence summaries. Isolation between the first and second instances may be achieved using separate operating system processes, container images, virtual machines, or hardware partitions, provided that the instances do not share parameters or internal state and interact only through prompts and structured challenge outputs.

In some implementations, the evidence retrieval and association components maintain one or more indexes over structured and unstructured data sources, such as document repositories, telemetry logs, mission databases, and sensor streams. Evidence items may be represented as records including content, metadata, and timestamp fields, and may be retrieved using keyword search, embedding based similarity search, or structured queries. Associations between semantic units and evidence items may be computed using cross attention mechanisms, relevance scoring functions, or heuristic matching rules, and stored in an evidence representation that also records evidence weights and challenge annotations.

The semantic support mask and token level inclusion mask may be represented as arrays or bit vectors indexed by semantic unit identifier and token position, respectively. In one embodiment, the governance engine constructs a token mask by mapping each token in the machine identified proposition to one or more semantic units, assigning an inclusion state based on the state of the corresponding semantic units, and then emitting a conservative rewrite as the subsequence of tokens for which the inclusion mask is true. This operation may be implemented efficiently using vectorized operations on token index arrays.

In some embodiments, governance profiles, constrained semantic grammars, and calibration parameters such as support thresholds, severity thresholds, and penalty factors are stored in configuration files or database tables that can be updated by authorized administrators. Configuration changes may be versioned and audited, and governance logs may record, for each governed proposition, the active governance profile, the semantic units and their states, the evidence items and challenge records considered, and the resulting governed text output and governance metrics.

The governance engine may expose application programming interfaces that allow upstream systems to submit prompts or candidate text and receive governed text outputs and governance metadata, and may also expose interfaces for downstream mission systems to subscribe to governance signals for gating actions, routing alerts, or enforcing policies. In some deployments, the governance engine operates in a headless mode as a backend service without a user interface; in other deployments, analyst facing interfaces provide visualizations of governed text, evidence, challenges, and support metrics for review, investigation, and tuning.

These implementation notes are provided as examples of how the disclosed systems and methods may be realized in practice. Many other implementation choices, including different programming languages, model serving frameworks, storage technologies, and deployment topologies, may be used without departing from the scope of the appended claims.

What is claimed is:

1. A computer-implemented method for governing outputs generated by a language model in a hardware-secured system, the method comprising:
(a) receiving an input prompt at a secure computing node coupled to a hardware timing subsystem comprising at least one of a precision time protocol (PTP) clock, a global positioning system (GPS) receiver, or an inertial measurement unit (IMU);
(b) causing a first transformer-based language model to generate a candidate text output containing at least one machine-identified proposition;
(c) assigning a proposition timestamp to the machine-identified proposition using a hardware-derived time signal from the hardware timing subsystem;
(d) segmenting the machine-identified proposition into a sequence of semantic units according to a constrained semantic grammar;
(e) retrieving a plurality of evidence items, wherein each evidence item is associated with a hardware-derived timestamp, and discarding any evidence item having a hardware-derived timestamp that violates a configured skew bound relative to the proposition timestamp;
(f) generating an adversarial challenge output by providing the machine-identified proposition and exclusively the remaining skew-compliant evidence items to a second transformer-based language model instance that is architecturally isolated from the first transformer-based language model;
(g) assigning a state to each semantic unit in the sequence based on the adversarial challenge output and an evidence weight of the remaining skew-compliant evidence items; and
(h) constructing a governed text output by:
(i) preserving a subsequence of tokens from the machine-identified proposition that correspond to semantic units assigned a first state; and
(ii) omitting tokens mapped exclusively to semantic units assigned a second state;
(iii) wherein the governed text output contains no new tokens not present in the candidate text output.

2. The method of claim 1, wherein the constrained semantic grammar is domain-specific and defines production rules that map propositions into semantic units including at least one of subject phrases, predicate phrases, modifier phrases, subordinate clauses, and domain specific units selected from a set including tactical entities, activities, locations, timeframes, capability modifiers, medical conditions, medical evidence modifiers, financial metrics, and risk modifiers.

3. The method of claim 1, wherein computing the support score for each semantic unit comprises, for a given semantic unit, computing a score based on a ratio of evidence weights to a penalty function of missing evidence indications associated with the semantic unit, and using a penalty factor specified by the governance profile.

4. The method of claim 1, wherein the support threshold and the severity threshold are specified in the governance profile on a per semantic unit type basis, and wherein comparing the support score to the support threshold comprises selecting different support thresholds for different semantic unit types as defined by the constrained semantic grammar.

5. The method of claim 1, wherein the predefined scale for numerical severity values is an integer scale from 1 to 10, and wherein the severity threshold specified by the governance profile is a value selected on the predefined scale based on empirical calibration for a domain of use.

6. The method of claim 1, wherein performing the syntactic and semantic integrity check comprises parsing the conservative rewritten proposition using the constrained semantic grammar and verifying that the conservative rewritten proposition conforms to production rules of the constrained semantic grammar for at least one well formed sentence structure.

7. The method of claim 1, further comprising, when the conservative rewritten proposition fails the syntactic and semantic integrity check, inserting one or more neutral placeholder units defined by the constrained semantic grammar to restore grammatical correctness while preserving the omission of tokens mapped exclusively to semantic units assigned the second state.

8. The method of claim 1, further comprising logging, to a governance log, for each machine identified proposition: the original proposition; the conservative rewritten proposition; the semantic support mask; associations between semantic units and evidence items; the structured challenge records; and one or more proposition level support metrics derived from the support scores and the semantic support mask.

9. The method of claim 8, further comprising exposing governed text outputs, proposition level support metrics, and governance state codes derived from the semantic support mask to a user interface configured for human analysts, wherein selecting a governed proposition in the user interface causes display of the original proposition, the conservative rewritten proposition, the semantic units and their assigned states, evidence items, and structured challenge records.

10. The method of claim 8, further comprising exporting governed text outputs, proposition level support metrics, and governance state codes derived from the semantic support mask to one or more downstream automated systems, wherein the downstream automated systems apply gating, alerting, or policy enforcement decisions based at least in part on the proposition level support metrics and governance state codes.

11. The method of claim 1, wherein the hardware timing subsystem includes at least one of a precision time protocol grandmaster, a global positioning system receiver, and an inertial measurement unit, and wherein discarding evidence items comprises discarding evidence items whose hardware derived timestamps differ from the proposition timestamp by more than a configured skew bound.

12. The method of claim 1, wherein identifying the machine identified proposition using token span extraction driven by dependency parsing comprises using a dependency parser to identify clause boundaries and extracting token spans corresponding to clauses that express distinct claims.

13. The method of claim 1, wherein constructing the adversarial prompt further comprises including configuration parameters from the governance profile, such that the second transformer-based language model instance generates adversarial challenge outputs conditioned on domain-specific sensitivity to unsupported inferences and missing evidence.

14. The method of claim 1, wherein the second transformer-based language model instance is deployed in a separate process, container, or virtual machine from the first transformer-based language model, and wherein communication between the first and second transformer-based language models is restricted to exchange of adversarial prompts and adversarial challenge outputs through a controlled interface.

15. The method of claim 1, wherein the governance pipeline is configured to produce governed text outputs and governance signals within a bounded end-to-end latency budget suitable for decision cycles of the mission critical environment.

16. A system for governing outputs generated by a transformer-based language model in a hardware secured mission critical environment, the system comprising:
a) at least one hardware processor;
b) a non-transitory computer readable memory storing instructions; and
c) a hardware timing subsystem, comprising at least one of a precision time protocol (PTP) grandmaster, a global positioning system (GPS) receiver, and an inertial measurement unit (IMU), configured to provide hardware derived timestamps,
d) wherein the instructions, when executed by the at least one hardware processor, cause the system to implement the method of any of claims 1 through 17, as amended.

17. A non-transitory computer readable medium storing instructions that, when executed by one or more hardware processors, cause performance of the method of claim 1.

18. The method of claim 1, wherein the constrained semantic grammar defines production rules segmenting the machine-identified proposition into semantic units corresponding to at least one of a subject phrase, a predicate phrase, a modifier phrase, or a subordinate clause.

19. The method of claim 1, wherein assigning a state to each semantic unit comprises:
a) parsing the adversarial challenge output into structured challenge records including a challenge type label and a severity value; and
b) assigning the second state to any semantic unit referenced by a challenge record having an “unsupported_inference” challenge type label and a severity value exceeding a severity threshold.

20. The method of claim 1, wherein the first transformer-based language model and the second transformer-based language model instance execute in separate hardware partitions or separate operating system containers that prevent parameter sharing.
